(19) United States
(12) Patent Application Publication
(10) Pub. No.: US 2025/0340721 A1
(43) Pub. Date: Nov. 6, 2025

(54) SYSTEM AND METHOD FOR PREPARING GRAPHENE OXIDE (GO)-MODIFIED NATURAL RUBBER MASTERBATCH BY AQUEOUS PHASE SYNERGISTIC AGGREGATING CO-COAGULATION PROCESS

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Shuaishuai CHENG, Taiyuan (CN); Xiaoyuan DUAN, Taiyuan (CN); Guizhe ZHAO, Taiyuan (CN)

(21) Appl. No.: 19/270,489

(22) Filed: Jul. 16, 2025

Related U.S. Application Data
(63) Continuation of application No. PCT/CN2024/131350, filed on Nov. 11, 2024.

(30) Foreign Application Priority Data
Jul. 19, 2024 (CN) 202410970123.1

(51) Int. Cl. C08K 9/04; C08J 3/22; C08J 3/28

(52) U.S. Cl. CPC C08K 9/04; C08J 3/22; C08J 3/28; C08J 2307/02; C08K 2201/001; C08K 2201/011

(57) ABSTRACT

A system for preparing a graphene oxide (GO)-modified natural rubber masterbatch by an aqueous phase synergistic aggregating co-coagulation process, including a first sub-system for preparing a modified GO aqueous dispersion and a second sub-system for preparing the GO-modified natural rubber masterbatch. The first sub-system includes a first storage tank for storing a GO slurry, a second storage tank for storing a modifier dispersion, and an ultrasonic reactor. The second sub-system includes a third storage tank for storing a natural rubber latex, a fourth storage tank for storing a flocculant, a mixing vessel, a flocculation device, and a rubber feeding device. The third storage tank and the ultrasonic reactor are communicated with the mixing vessel through pipelines, respectively. A method for preparing a GO-modified natural rubber masterbatch by an aqueous phase synergistic aggregating co-coagulation process is also provided.

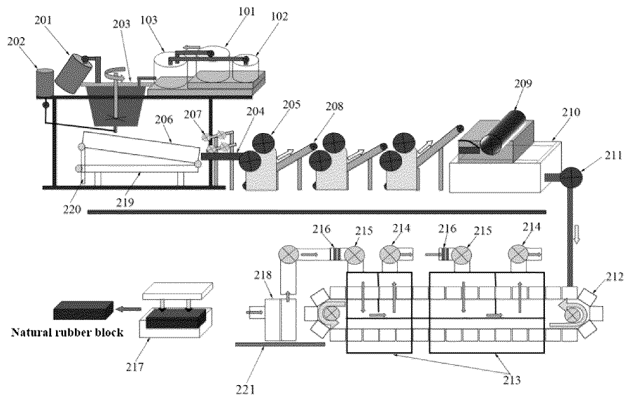

### CROSS-REFERENCE TO RELATED APPLICATIONS

This application is a continuation of International Patent Application No. PCT/CN2024/131350, filed on Nov. 11, 2024, which claims the benefit of priority from Chinese Patent Application No. 202410970123.1, filed on Jul. 19, 2024. The content of the aforementioned application, including any intervening amendments made thereto, is incorporated herein by reference in its entirety.

### TECHNICAL FIELD

This application relates to rubber production, and more particularly to a system and method for preparing a graphene oxide (GO)-modified natural rubber masterbatch by an aqueous phase synergistic aggregating co-coagulation process.

### BACKGROUND

Natural rubber is a naturally-occurring polymer compound with cis-1,4-polyisoprene as the main component. It is an elastic solid made from natural latex collected from rubber trees through solidification, drying, and other processing procedures. It has been widely used as a raw material in the industrial fields such as tires, conveyor belts, hoses, and sealing rings.

Graphene is a novel material consisting of a single-layer two-dimensional (2D) honeycomb lattice structure formed by compact packing of sp² hybridized carbon atoms. It has excellent optical, electrical, and mechanical properties, holding vast application prospects in materials, micro-nano processing, energy, biomedicine, and drug delivery, and is considered as a revolutionary material in the future. One of the most representative derivatives, graphene oxide (GO), is a 2D material with multiple oxygen-containing functional groups obtained by oxidizing graphite by physical and chemical means.

The exceptional mechanical strength, electrical conductivity, and thermal conductivity of the graphene and derivatives thereof have led to their widespread use in rubber reinforcement and modification. This enables the production of rubber products with enhanced mechanical strength, toughness, and thermal conductivity. However, the latex co-precipitation method that is currently used for preparing graphene-modified natural rubber masterbatch has problems such as long production cycle and high energy consumption due to the dehydration and drying process. In addition, this may lead to increased cost, which has become one of the major obstacle hindering the application of graphene-modified natural rubber.

In addition, most of the existing natural rubber masterbatch production lines are “standard rubber” production lines and “full latex” production lines, which face the following problems. Firstly, the immediate modification and utilization of GO cannot be achieved in the production line, leading to reduced activity of modified GO, and thus making it impossible to obtain high-performance masterbatch. Moreover, the complicated production processes require substantial workforce. Secondly, the production lines typically employ hot-air drying at 60° C., which is a compromise solution that comprehensively considers the drying efficiency and the quality of dried rubber. However, this still leads to inefficient drying and inconsistent quality of the dried masterbatch.

### SUMMARY

In order to address the problems of complicated production steps and unstable quality of dried rubber in the existing natural rubber production lines, this application provides a system and method for preparing a graphene oxide (GO)-modified natural rubber masterbatch by an aqueous phase synergistic aggregating co-coagulation process, which enables full-process monitoring and automated control of the masterbatch system, thereby reducing manual operation intensity, enhancing production efficiency, and product quality stability, so as to achieve consistent production of high-performance graphene-modified natural rubber masterbatch.

Technical solutions of the present disclosure are described as follows.

In a first aspect, this application provides a system for preparing a GO-modified natural rubber masterbatch by an aqueous phase synergistic aggregating co-coagulation process, comprising:
a first sub-system for preparing a modified GO aqueous dispersion; and
a second sub-system for preparing the GO-modified natural rubber masterbatch;
wherein the first sub-system comprises a first storage tank for storing a GO slurry, a second storage tank for storing a modifier dispersion and an ultrasonic reactor;
the first storage tank is communicated with the ultrasonic reactor through a first pipeline, and the second storage tank is communicated with the ultrasonic reactor through a second pipeline; and the first pipeline is provided with a first metering pump connected in series with the first storage tank and the ultrasonic reactor, and the second pipeline is provided with a second metering pump connected in series with the second storage tank and the ultrasonic reactor;
the second sub-system comprises a third storage tank for storing a natural rubber latex, a fourth storage tank for storing a flocculant, a mixing vessel, a flocculation device and a rubber feeding device; the third storage tank is communicated with the mixing vessel through a third pipeline, and the ultrasonic reactor is communicated with the mixing vessel through a fourth pipeline; and the third pipeline is provided with a third metering pump connected in series with the third storage tank and the mixing vessel, and the fourth pipeline is provided with a fourth metering pump connected in series with the ultrasonic reactor and the mixing vessel;
the flocculation device comprises a flocculation tank and a support base; the flocculation tank is communicated with the fourth storage tank through a fifth pipeline; the fifth pipeline is provided with a fifth metering pump connected in series with the fourth storage tank and the flocculation tank; the flocculation tank is arranged on the support base; a bottom of a discharge end of the flocculation tank is rotatably connected to an edge of an upper surface of the support base; a lifting cylinder is provided at a side of the support base away from the discharge end of the flocculation tank; and a telescopic end of the lifting cylinder passes through the support base to attach to and support a bottom of a feed end of the flocculation tank;
the rubber feeding device comprises a rubber feeding platform and a conveying roller rotatably arranged on the rubber feeding platform; at least one creping machine is sequentially arranged at a discharge end of the conveying roller, and a discharge end of each of the at least one creping machine is provided with a transmission belt; a discharge end of the transmission belt corresponding to one of the at least one creping machine farthest from the discharge end of the conveying roller is located above a feed end of a shredder; a discharge end of the shredder is communicated with a feed end of a cleaning pool; and a discharge end of the cleaning pool is provided with a feeding pump, and a discharge end of the feeding pump is connected to a drying mechanism through a sixth pipeline;
the drying mechanism comprises a conveyor belt; the conveyor belt is located below the discharge end of the feeding pump, and is provided with two drying chambers arranged side by side along a material conveying direction; the conveyor belt is configured to be driven by a driving mechanism to convey a material in the two drying chambers; the two drying chambers are each provided with a heat-insulation door curtain; a top of each of the two drying chambers is provided with a centrifugal fan and an air supply fan; an air inlet of the air supply fan is provided with a heating device; an air outlet of the air supply fan is connected to an air inlet of a corresponding one of the two drying chambers; an air inlet of the centrifugal fan is connected to an air outlet of a corresponding one of the two drying chambers; and a side of an end of an air inlet pipeline of at least one of the two drying chambers close to the heating device is provided with a drying device, and the drying device is filled with a drying medium; and the conveyor belt is configured to convey the material to a material platform.

In some embodiments, the system further comprises a packing machine.

In some embodiments, the ultrasonic reactor is set at 1-10 KW and 25-120° C.

In a second aspect, this application provides a method for preparing a GO-modified natural rubber masterbatch by an aqueous phase synergistic aggregating co-coagulation process using the above system, comprising:
(1) pumping, by the third metering pump, the natural rubber latex from the third storage tank into the mixing vessel followed by dilution with deionized water to obtain a natural rubber latex dispersion with a preset concentration;
(2) pumping, by the first metering pump, the GO slurry from the first storage tank to the ultrasonic reactor, and pumping, by the second metering pump, the modifier dispersion from the second storage tank to the ultrasonic reactor for reaction at a preset temperature for a preset period to obtain the modified GO aqueous dispersion;
(3) mixing the modified GO aqueous dispersion with the natural rubber latex dispersion in the mixing vessel followed by stirring to obtain a GO-modified natural rubber mixed emulsion; and sequentially adding the GO-modified natural rubber mixed emulsion and the flocculant in the fourth storage tank to the flocculation tank followed by mixing for flocculation to obtain a flocculated GO-modified natural rubber block;
(4) dragging, by the rubber feeding device, the flocculated GO-modified natural rubber block to sequentially pass through the at least one creping machine and the transmission belt for continuous creping to obtain a rubber sheet, and controlling a rotation speed of the at least one creping machine according to a rubber output speed, so that the rubber sheet passes through the transmission belt farthest from the discharge end of the conveying roller to be transported to the shredder for granulation to obtain rubber crumbs without causing clogging;
(5) cleaning and deacidifying the rubber crumbs in the cleaning pool, and pumping, by the feeding pump, the rubber crumbs to the conveyor belt; transporting, by the air supply fan, heated air generated by the heating device to the two drying chambers; discharging, by the centrifugal fan, humid air from the two drying chambers; transporting the rubber crumbs on the conveyor belt to sequentially pass through the two drying chambers for drying to obtain dried rubber crumbs, wherein most moisture of the rubber crumbs are removed at a first temperature in a first one of the two drying chambers along a conveying direction, and remaining moisture of the rubber crumbs are removed by dry air with a second temperature in a second one of the two drying chambers along the conveying direction, and the first temperature is larger than the second temperature; and
(6) weighing the dried rubber crumbs; and packing, by a packing machine, the dried rubber crumbs to obtain a GO-modified natural rubber masterbatch product.

In some embodiments, in step (1), a concentration of the natural rubber latex is set to enable the third metering pump to stably supply the natural rubber latex.

In some embodiments, in step (2), a concentration of the GO slurry is set to enable the first metering pump to stably supply the GO slurry, and a concentration of the modifier dispersion is set to enable the second metering pump to stably supply the modifier dispersion.

In some embodiments, in step (5), the first one of the two drying chambers is set at 60-95° C., and the second one of the two drying chambers is set at 25-60° C.

Compared to the prior art, the present disclosure has the following beneficial effects.
(1) The system of the present disclosure can realize modification of GO and immediate use for incorporation into natural rubber latex, which ensures the production of high-performance masterbatch. Furthermore, the motor speed and rubber drying temperature can be regulated according to real-time information of each device, resulting in high quality stability of masterbatch products. Therefore, this system has characteristics of low cost, high efficiency, high stability, and intelligence.
(2) The present disclosure adopts a segmented drying process, which employs high-temperature air during the earlier stage for rapid removal of bulk moisture, followed by low-temperature dry air in the later stage to actively extract the remaining moisture. This can enhance production efficiency of the modified natural rubber masterbatch and ensure the quality stability.
(3) Automated coordination among system components reduces manual labor requirements and operation intensity. In addition, the disclosure leads to simplified process, shortened drying cycle and low terminal drying temperature, which can effectively improve the production efficiency and product quality of the GO-modified natural rubber masterbatch.

### BRIEF DESCRIPTION OF THE DRAWINGS

The accompanying drawings, which are incorporated into and constitute a part of this specification, are intended to illustrate the embodiments of the disclosure, and are used for explaining the principles of the disclosure in conjunction with the specification.

In order to illustrate the technical solutions in the embodiments of the present disclosure or in the prior art more clearly, the drawings needed in the description of embodiments or the prior art will be briefly introduced below. Obviously, for those of ordinary skill in the art, other drawings can be obtained based on these drawings without exerting creative efforts.

The FIGURE is a schematic diagram of a system for preparing a graphene oxide (GO)-modified natural rubber masterbatch in accordance with an embodiment of the present disclosure.

In the drawings: 101—first storage tank; 102—second storage tank; 103—ultrasonic reactor; 201—third storage tank; 202—fourth storage tank; 203—mixing vessel; 204—rubber feeding platform; 205—creping machine; 206—flocculation tank; 207—conveying roller; 208—transmission belt; 209—shredder; 210—cleaning pool; 211—feeding pump; 212—conveyor belt; 213—drying chamber; 214—centrifugal fan; 215—air supply fan; 216—heating device; 217—packing machine; 218—drying device; 219—support base; 220—lifting cylinder; and 221—material platform.

### DETAILED DESCRIPTION OF EMBODIMENTS

In order to make the purpose, technical solutions and advantages of the embodiments of the present disclosure clearer, the technical solutions in the embodiments of the present disclosure will be clearly and completely described below. It should be noted that, as long as there is no contradiction, the embodiments of the present disclosure and the features therein can be combined with each other.

Many specific details are set forth in the following description to facilitate the full understanding of the present disclosure, but the present disclosure can also be implemented in other ways different from those described herein. Obviously, provided herein are merely some of the embodiments of the disclosure, instead of all of the embodiments.

### Example 1

As shown in the FIGURE, a system for preparing a graphene oxide (GO)-modified natural rubber masterbatch by an aqueous phase synergistic aggregating co-coagulation process is provided, including a first sub-system for preparing a modified GO aqueous dispersion and a second sub-system for preparing the GO-modified natural rubber masterbatch.

The first sub-system includes a first storage tank 101 for storing a GO slurry, a second storage tank 102 for storing a modifier dispersion, and an ultrasonic reactor 103. The first storage tank 101 is communicated with the ultrasonic reactor 103 through a first pipeline. The second storage tank 102 is communicated with the ultrasonic reactor 103 through a second pipeline. The first pipeline is provided with a first metering pump connected in series with the first storage tank 101 and the ultrasonic reactor 103. The second pipeline is provided with a second metering pump connected in series with the second storage tank 102 and the ultrasonic reactor 103.

A concentration of the GO slurry is set to enable the first metering pump to stably supply the GO slurry. A concentration of the modifier dispersion is set to enable the second metering pump to stably supply the modifier dispersion. The ultrasonic reactor 103 is set at 8 kW and 70° C.

The second sub-system includes a third storage tank 201 for storing a natural rubber latex, a fourth storage tank 202 for storing a flocculant, a mixing vessel 203, a flocculation device, and a rubber feeding device. The third storage tank 201 is communicated with the mixing vessel 203 through a third pipeline. The ultrasonic reactor 103 is communicated with the mixing vessel 203 through a fourth pipeline. The third pipeline is provided with a third metering pump connected in series with the third storage tank 201 and the mixing vessel 203. The fourth pipeline is provided with a fourth metering pump connected in series with the ultrasonic reactor 103 and the mixing vessel 203.

The flocculation device includes a flocculation tank 206 communicated with the fourth storage tank 202 through a fifth pipeline. The fifth pipeline is provided with a fifth metering pump connected in series with the fourth storage tank 202 and the flocculation tank 206. The rubber feeding device includes a rubber feeding platform 204 and a conveying roller 207 rotatably arranged on the rubber feeding platform 204. Three creping machines 205 are sequentially arranged at a discharge end of the conveying roller 207. Discharge ends of the three creping machines 205 are respectively provided with transmission belts 208. A discharge end of one of the transmission belts 208 farthest from the discharge end of the conveying roller 207 is located above a feed end of a shredder 209. A discharge end of the shredder 209 is communicated with a feed end of a cleaning pool 210. A discharge end of the cleaning pool 210 is provided with a feeding pump 211. A discharge end of the feeding pump 211 is connected to a drying mechanism through a sixth pipeline.

The drying mechanism includes a conveyor belt 212. The conveyor belt 212 is located below the discharge end of the feeding pump 211, and is provided with two drying chambers 213 arranged side by side along a material conveying direction. The conveyor belt 212 is configured to be driven by a driving mechanism to convey a material in the two drying chambers 213. The two drying chambers 213 are each provided with a heat-insulation door curtain. A top of each of the two drying chambers 213 is provided with a centrifugal fan 214 and an air supply fan 215. An air inlet of the air supply fan 215 is provided with a heating device 216. An air outlet of the air supply fan 215 is connected to air inlets of a corresponding one of the two drying chambers 213. An air inlet of the centrifugal fan 214 is connected to an air outlet of a corresponding one of the two drying chambers 213. A side of an end of an air inlet pipeline of one of the two drying chambers 213 close to the heating device is provided with a drying device 218. The drying device 218 is filled with a drying medium. In this embodiment, a first one of the two drying chambers 213 along a conveying direction adopted a high-power heating and ventilation device with a heating power of about 200 kW to achieve rapid removal of most moisture of the rubber crumbs at a first temperature, and a second one of the two drying chambers 213 along the conveying direction adopted a high-power dry air ventilation device with a heating power of about 200 kW to achieve rapid removal of the remaining moisture of the rubber crumbs through dry air at a second temperature, where the first temperature was larger than the second temperature, thereby improving the production efficiency and quality stability of the modified natural rubber masterbatch.

The conveyor belt 212 is configured to convey the material to a material platform 221.

In this embodiment, in order to facilitate dragging the GO-modified natural rubber masterbatch from the flocculation tank 206 to the conveying roller 207, the flocculation device further includes a support base 219. The flocculation tank 206 is arranged on the support base 219. A bottom of a discharge end of the flocculation tank 206 is rotatably connected to an edge of an upper surface of the support base 219. A lifting cylinder 220 is provided at a side of the support base 219 away from the discharge end of the flocculation tank. A telescopic end of the lifting cylinder 220 passes through the support base 219 to attach to and support a bottom of a feed end of the flocculation tank 206. After the mixed emulsion is flocculated, the lifting cylinder 220 is started, and the telescopic end of the lifting cylinder 220 passes through the support base 219. As the feed end of the flocculation tank 206 continues to be lifted, a contact point between the telescopic end of the lifting cylinder 220 and the bottom of the discharge end of the flocculation tank 206 moves from inside to outside until the feed end of the flocculation tank 206 is lifted to a required height.

As shown in the FIGURE, the system further includes a packing machine 217.

The specific production process includes the following steps.
(S1) The natural rubber latex was pumped from the third storage tank 201 into the mixing vessel 203 by the third metering pump. Then, deionized water was mixed with the natural rubber latex for dilution to obtain a natural rubber latex dispersion.
(S2) The GO slurry (with a concentration of 1 wt. %) was pumped from the first storage tank 101 into the ultrasonic reactor 103 by the first metering pump, and the modifier dispersion (with a concentration of 2 wt. %) was pumped from the second storage tank 102 into the ultrasonic reactor 103 by the second metering pump for reaction at a preset temperature for a preset period to obtain the modified GO aqueous dispersion.
(S3) The modified GO aqueous dispersion was mixed with the natural rubber latex dispersion in the mixing vessel 203 followed by stirring to obtain a uniform GO-modified natural rubber mixed emulsion. The GO-modified natural rubber mixed emulsion and the flocculant in the fourth storage tank 202 were added to the flocculation tank 206 and mixed evenly for flocculation to obtain a flocculated GO-modified natural rubber block.
(S4) The flocculated GO-modified natural rubber block was dragged by the rubber feeding device to sequentially pass through each creping machine 205 and the transmission belt 208 by the rubber feeding device for continuous creping. A rotation speed of the creping machines 205 was controlled according to a rubber output speed, so that the rubber sheet passed through the last transmission belt 208 (farthest from the discharge end of the conveying roller 207) evenly to be transported to the shredder 209 for granulation to obtain rubber crumbs without clogging.
(S5) The rubber crumbs were cleaned and deacidified in the cleaning pool 210, and then pumped to the conveyor belt 212 by the feeding pump 211. A heated air generated by the heating device 216 was transported to the two drying chambers 213 by the air supply fan 215. Humid air was discharged from the two drying chambers 213 by the centrifugal fan 214. In this embodiment, temperature sensors were respectively arranged in the two drying chambers 213 to acquire corresponding temperatures. A programmable logic controller (PLC) was adapted to adjust a power of the heating device 216 according to a preset drying temperature. A required drying temperature and drying time were obtained through a temperature and humidity at the air outlet of the two drying chambers 213. In specific implementation, the drying temperature and drying time in the two drying chambers 213 were shown in Table 2. The rubber crumbs on the conveyor belt 212 were sequentially transported to pass through the two drying chambers 213 for drying to obtain dried rubber crumbs.
(S6) The dried rubber crumbs were quantitatively weighed, and then packaged by the packing machine, so as to obtain a high-performance GO-modified natural rubber masterbatch product.

### Comparative Example 1

The preparation method provided herein was basically the same as that in Example 1, except that in step (S5), the two drying chambers 213 were set at 60° C. until reaching a constant weight.

### Comparative Example 2

The preparation method provided herein was basically the same as that in Example 1, except that the modified GO was not added, the two drying chambers 213 were set at 60° C. until reaching a constant weight.

### Comparative Example 3

The preparation method provided herein was basically the same as that in Example 1, except that in step (S5), the two drying chambers 213 were set at 80° C. until reaching a constant weight.

In order to obtain mechanical properties of vulcanized rubbers prepared based on the masterbatches in Example 1 and Comparative Examples 1-3, the vulcanized rubbers were prepared through the following steps. The GO-modified natural rubber masterbatch was placed in an internal mixer, mixed at 110° C. for 16 min and then discharged. During this period, 100 phr of the NR in the GO-modified natural rubber masterbatch, 2 phr of N-cyclohexyl-2-benzothiazole sulfonamide (accelerator CZ), 2 phr of 2,2,4-trimethyl-1,2-dihydroquinoline polymer (anti-aging agent RD), 2 phr of N-(1,3-dimethylbutyl)-N′-phenyl-1,4-phenylenediamine (antioxidant 4020), 5 phr of zinc oxide (as an activator), 2 phr of stearic acid (as a plasticizer) and 35 phr of carbon black (as a reinforcing filler) were added in sequence. The discharged rubber was cooled to room temperature, milled on an open mill at 60° C. for 10 min with 2 phr of sulfur being added during this period for evenly mixing, and thinly passed until there were no bubbles in the rubber to obtain a mixed rubber. The mixed rubber was placed at room temperature for 24 h, subjected to hot-press vulcanization in a mold at 150° C. and 15 MPa, and the vulcanization time was Tc₉₀ (determined by a rubber processing analyzer). Finally, a vulcanized graphene-modified natural rubber was obtained.

The performance tests were performed on the vulcanized natural rubber composites prepared based on the masterbatches in Example 1 and Comparative Examples 1-3. The tensile properties were tested according to GB/T 528-2009 with a tensile rate of 500 mm/min. The tear properties were tested according to GB/T 529-2008. The vulcanization time Tc₉₀ was measured by a rubber processing analyzer. Table 1 shows formula of the performance test rubbers of Example 1 and Comparative Examples 1-3. Table 2 shows comprehensive properties of rubber composites of Example 1 and Comparative Examples 1-3.

TABLE 1
Formula of Example 1 and Comparative Examples 1-3

| | Compar- | Compar- | Compar- | |
|---|---|---|---|---|
| | ative | ative | ative | |
| Samples | Example 1 | Example 2 | Example 3 | Example 1 |
| Natural rubber (phr) | 100 | 100 | 100 | 100 |
| Antioxidant 4020 (phr) | 2 | 2 | 2 | 2 |
| Anti-aging agent RD | 2 | 2 | 2 | 2 |
| (phr) | | | | |
| Zinc oxide (phr) | 5 | 5 | 5 | 5 |
| Stearic acid (phr) | 2 | 2 | 2 | 2 |
| Carbon black (phr) | 35 | 35 | 35 | 35 |
| Accelerator CZ (phr) | 2 | 2 | 2 | 2 |
| Sulfur (phr) | 2 | 2 | 2 | 2 |

TABLE 2
Comprehensive properties of rubber composites
of Example 1 and Comparative Examples 1-3

| | Comparative | | Comparative | | Comparative | | |
|---|---|---|---|---|---|---|---|
| | Example 1 | | Example 2 | | Example 3 | Example 1 | |
| Drying | 60° | C. | 60° | C. | 80° C. | First | Second |
| temperature | | | | | | one of the | one of the |
| | | | | | | two drying | two drying |
| | | | | | | chambers | chambers |
| | | | | | | at 80° C. | at 40° C. |
| Drying | Hot air drying | | Hot air drying | | Hot air drying | First | Second |
| method | | | | | | one of the | one of the |
| | | | | | | two drying | two drying |
| | | | | | | chambers | chambers |
| | | | | | | for hot air | for hot dry |
| | | | | | | drying | air drying |
| Drying time | 20 | h | 20 | h | 9 h (outer layer | 6 h | 4 h |
| (to constant | | | | | in a visco-flow | | |
| weight) | | | | | state, inner | | |
| | | | | | part remained | | |
| | | | | | undried) | | |

| | | | | |
|---|---|---|---|---|
| Content of | 1 | 0 | 1 | 1 |
| modified | | | | |
| GO (phr) | | | | |
| Mooney | 68 | 70 | 55 | 73 |
| viscosity | | | | |
| (MU) | | | | |
| Plasticity | 60 | 60 | 30 | 65 |
| value | | | | |
| Tensile | 25.9 | 24.5 | — | 28.6 |
| strength | | | | |
| (MPa) | | | | |
| Breaking | 420 | 400 | — | 440 |
| elongation | | | | |
| (%) | | | | |
| Tear | 71 | 64 | — | 83 |
| strength | | | | |
| (N/mm) | | | | |
| Hardness | 60 | 59.5 | — | 61.5 |
| (HA) | | | | |
| Heat build- | 10.5 | 11.5 | — | 11.0 |
| up value | | | | |
| (° C.) | | | | |

As shown in Table 2, compared with the GO-modified natural rubber masterbatches and the vulcanized rubbers prepared therefrom in Comparative Examples 1-3, the high-performance GO-modified natural rubber masterbatch of the present disclosure (Example 1) has a higher Mooney viscosity and plasticity value, which can avoid sticking to the roller during the mixing stage. Moreover, the tensile strength, tear strength, hardness, dynamic compression heat build-up performance, and other comprehensive properties of the vulcanized rubber prepared from the GO-modified natural rubber masterbatch of the present disclosure are all improved. In addition, this leads to a shortest drying time compared with the vulcanized rubbers of Comparative Examples 1-3, resulting in an improved production efficiency.

The embodiments described above are merely illustrative of the present application to enable those skilled in the art to understand or implement the present disclosure, instead of limiting the scope of the present application. Although the disclosure has been described in detail with reference to the above embodiments, various variations, replacements and modifications can still be made by those skilled in the art to the technical solutions recited in the above embodiments. It should be understood that those modifications, variations and replacements made without departing from the spirit of the disclosure shall fall within the scope of the disclosure defined by the appended claims.

What is claimed is:

1. A system for preparing a graphene oxide (GO)-modified natural rubber masterbatch by an aqueous phase synergistic aggregating co-coagulation process, comprising:
a first sub-system for preparing a modified GO aqueous dispersion; and
a second sub-system for preparing the GO-modified natural rubber masterbatch;
wherein the first sub-system comprises a first storage tank for storing a GO slurry, a second storage tank for storing a modifier dispersion, and an ultrasonic reactor;
the first storage tank is communicated with the ultrasonic reactor through a first pipeline, and the second storage tank is communicated with the ultrasonic reactor through a second pipeline; and the first pipeline is provided with a first metering pump connected in series with the first storage tank and the ultrasonic reactor, and the second pipeline is provided with a second metering pump connected in series with the second storage tank and the ultrasonic reactor;
the second sub-system comprises a third storage tank for storing a natural rubber latex, a fourth storage tank for storing a flocculant, a mixing vessel, a flocculation device, and a rubber feeding device; the third storage tank is communicated with the mixing vessel through a third pipeline, and the ultrasonic reactor is communicated with the mixing vessel through a fourth pipeline; and the third pipeline is provided with a third metering pump connected in series with the third storage tank and the mixing vessel, and the fourth pipeline is provided with a fourth metering pump connected in series with the ultrasonic reactor and the mixing vessel;
the flocculation device comprises a flocculation tank and a support base; the flocculation tank is communicated with the fourth storage tank through a fifth pipeline; the fifth pipeline is provided with a fifth metering pump connected in series with the fourth storage tank and the flocculation tank; the flocculation tank is arranged on the support base; a bottom of a discharge end of the flocculation tank is rotatably connected to an edge of an upper surface of the support base; a lifting cylinder is provided at a side of the support base away from the discharge end of the flocculation tank; and a telescopic end of the lifting cylinder passes through the support base to attach to and support a bottom of a feed end of the flocculation tank;
the rubber feeding device comprises a rubber feeding platform and a conveying roller rotatably arranged on the rubber feeding platform; at least one creping machine is sequentially arranged at a discharge end of the conveying roller, and a discharge end of each of the at least one creping machine is provided with a transmission belt; a discharge end of the transmission belt corresponding to one of the at least one creping machine farthest from the discharge end of the conveying roller is located above a feed end of a shredder; a discharge end of the shredder is communicated with a feed end of a cleaning pool; and a discharge end of the cleaning pool is provided with a feeding pump, and a discharge end of the feeding pump is connected to a drying mechanism through a sixth pipeline;
the drying mechanism comprises a conveyor belt; the conveyor belt is located below the discharge end of the feeding pump, and is provided with two drying chambers arranged side by side along a material conveying direction; the conveyor belt is configured to be driven by a driving mechanism to convey a material in the two drying chambers; the two drying chambers are each provided with a heat-insulation door curtain; a top of each of the two drying chambers is provided with a centrifugal fan and an air supply fan; an air inlet of the air supply fan is provided with a heating device; an air outlet of the air supply fan is connected to an air inlet of a corresponding one of the two drying chambers; an air inlet of the centrifugal fan is connected to an air outlet of a corresponding one of the two drying chambers; and a side of an end of an air inlet pipeline of a last one of the two drying chambers close to the heating device is provided with a drying device, and the drying device is filled with a drying medium; and
the conveyor belt is configured to convey the material to a material platform.

2. The system of claim 1, further comprising:
a packing machine.

3. The system of claim 1, wherein the ultrasonic reactor is set at 1-10 KW and 25-120° C.

4. A method for preparing a GO-modified natural rubber masterbatch by an aqueous phase synergistic aggregating co-coagulation process using the system of claim 1, comprising:
(1) pumping, by the third metering pump, the natural rubber latex from the third storage tank into the mixing vessel followed by dilution with deionized water to obtain a natural rubber latex dispersion with a preset concentration;
(2) pumping, by the first metering pump, the GO slurry from the first storage tank to the ultrasonic reactor, and pumping, by the second metering pump, the modifier dispersion from the second storage tank to the ultrasonic reactor for reaction at a preset temperature for a preset period to obtain the modified GO aqueous dispersion;
(3) mixing the modified GO aqueous dispersion with the natural rubber latex dispersion in the mixing vessel followed by stirring to obtain a GO-modified natural rubber mixed emulsion; and sequentially adding the GO-modified natural rubber mixed emulsion and the flocculant in the fourth storage tank to the flocculation tank followed by mixing for flocculation to obtain a flocculated GO-modified natural rubber block;
(4) dragging, by the rubber feeding device, the flocculated GO-modified natural rubber block to sequentially pass through the at least one creping machine and the transmission belt for continuous creping to obtain a rubber sheet, and controlling a rotation speed of the at least one creping machine according to a rubber output speed, so that the rubber sheet passes through the transmission belt farthest from the discharge end of the conveying roller to be transported to the shredder for granulation to obtain rubber crumbs without clogging;
(5) cleaning and deacidifying the rubber crumbs in the cleaning pool, and pumping, by the feeding pump, the rubber crumbs to the conveyor belt; transporting, by the air supply fan, heated air generated by the heating device to the two drying chambers; discharging, by the centrifugal fan, humid air from the two drying chambers; transporting the rubber crumbs on the conveyor belt to sequentially pass through the two drying chambers for drying to obtain dried rubber crumbs, wherein most moisture of the rubber crumbs are removed at a first temperature in a first one of the two drying chambers along a conveying direction, and remaining moisture of the rubber crumbs are removed by dry air with a second temperature in a second one of the two drying chambers along the conveying direction, and the first temperature is larger than the second temperature; and
(6) weighing the dried rubber crumbs; and packing, by a packing machine, the dried rubber crumbs to obtain a GO-modified natural rubber masterbatch product.

5. The method of claim 4, wherein in step (1), a concentration of the natural rubber latex is set to enable the third metering pump to stably supply the natural rubber latex.

6. The method of claim 4, wherein in step (2), a concentration of the GO slurry is set to enable the first metering pump to stably supply the GO slurry; and a concentration of the modifier dispersion is set to enable the second metering pump to stably supply the modifier dispersion.

7. The method of claim 4, wherein in step (5), the first one of the two drying chambers is set at 60-95° C., and the second one of the two drying chambers is set at 25-60° C.
